(19) United States
(12) Patent Application Publication
(10) Pub. No.: US 2025/0287198 A1
(43) Pub. Date: Sep. 11, 2025

(54) AVOIDING VENDOR SPECIFIC PHYSICAL PROTOCOL DATA UNIT (PPDU) VIA PROTECTED ASSOCIATION IDENTIFIER (AID) CHANGE REQUEST

(71) Applicant: Cisco Technology, Inc., San Jose, CA (US)

(72) Inventors: Brian D. HART, Sunnyvale, CA (US); Binita GUPTA, San Diego, CA (US)

(21) Appl. No.: 19/023,088

(22) Filed: Jan. 15, 2025

Related U.S. Application Data
(60) Provisional application No. 63/563,846, filed on Mar. 11, 2024.

(51) Int. Cl. H04W 12/02; H04L 61/3015; H04W 12/0471; H04W 28/16

(52) U.S. Cl. CPC H04W 12/02; H04L 61/3015; H04W 12/0471; H04W 28/16

(57) ABSTRACT

The present disclosure provides techniques to avoid conflicts in vendor-specific negotiation by using a protected AID change request. A client device sends an association request to a network device. The client device receives an association identifier (AID) from the network device in response to the association request. The client device determines that the AID conflicts with one or more existing AIDs already assigned to the client device. In response to the determination, the client device sends an AID change request to the network device for a new AID. The client device receives the new AID from the network device, and confirms that the new AID does not conflict with the one or more existing AIDs. In response to the confirmation, the client devices complete a negotiation of one or more vendor-specific features with the network device using the new AID.

### CROSS-REFERENCE TO RELATED APPLICATIONS

This application claims benefit of co-pending U.S. provisional patent application Ser. No. 63/563,846 filed Mar. 11, 2024. The aforementioned related patent application is herein incorporated by reference in its entirety.

### TECHNICAL FIELD

Embodiments presented in this disclosure generally relate to wireless communication. More specifically, embodiments disclosed herein relate to avoiding conflicts in vendor-specific (VS) negotiation through a protected association identifier (AID) change request.

### BACKGROUND

Wi-Fi communication between client devices and access points (APs) typically follows industry-defined protocols to ensure interoperability across different vendors. However, Wi-Fi silicon vendors often wish to introduce proprietary physical (PHY)-layer features that can provide competitive advantages and optimize performance for their specific devices. To achieve this, vendor devices need a reliable method to communicate their proprietary features to the AP, especially when connecting to multiple networks. The communication enables that vendor-specific capabilities are properly recognized and do not interference with third-party products. Additionally, a mechanism is needed to monitor and verify the proper application of these features across different connections to prevent errors and maintain accurate performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless environment where a client device connects to two different networks, according to some embodiments of the present disclosure.

FIG. 2 depicts an example ultra-high reliability (UHR) physical protocol data unit (PPDU), according to some embodiments of the present disclosure.

FIG. 3 depicts an example management frame with an AID List Veto element, according to some embodiments of the present disclosure.

FIG. 4 depicts an example sequence of message exchanges between a client device and an AP for association, AID assignment, and vendor-specific feature negotiation, according to some embodiments of the present disclosure.

FIG. 5 depicts an example method for a client device handling AID conflict and vendor-specific negotiation, according to some embodiments of the present disclosure.

FIG. 6 depicts an example method for an AP handling AID conflict and vendor-specific negotiation, according to some embodiments of the present disclosure.

FIG. 7 is a flow diagram depicting an example method for AID conflict resolution, according to some embodiments of the present disclosure.

FIG. 8 depicts an example client device configured to perform various aspects of the present disclosure, according to some aspects of the present disclosure.

FIG. 9 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including sending, by a client device, an association request to a network device; receiving, by the client device, an association identifier (AID) from the network device in response to the association request; determining, by the client device, that the AID conflicts with one or more existing AIDs already assigned to the client device, in response to the determination, sending, by the client device, an AID change request to the network device for a new AID, receiving, by the client device, the new AID from the network device in response to the AID change request, confirming, by the client device, that the new AID does not conflict with the one or more existing AIDs, and in response to the confirmation, completing, by the client device, a negotiation of one or more vendor-specific features with network device using the new AID.

Other embodiments in this disclosure provide one or more non-transitory computer-readable media containing, in any combination, computer program code that, when executed by a computer system, performs an operation in accordance with one or more of the above methods, as well as a system of a client device comprising one or more computer processors, and one or more memories collectively containing one or more programs, which, when executed by the one or more computer processors, perform an operation in accordance with one or more of the above methods.

### EXAMPLE EMBODIMENTS

The introduction of proprietary PHY-layer features can bring significant performance enhancements to Wi-Fi systems. These features may include higher modulation orders, custom forward error correction (FEC) codes, advanced techniques for channel smoothing, or improvements in ranging accuracy. Additionally, Wi-Fi silicon vendors may highlight specific capabilities, such as transmitters with particular low error vector magnitude (EVM), low phase noise, or with constellation shaping for more efficient signal transmission.

One mechanism for communicating proprietary vendor-specific features between a client device and an AP is through the use of reserved bits in the signal (SIG) fields of PPDUs. This method enables devices to optimize communication when both the client and AP support the same vendor-specific features while maintaining compatibility with standard-compliant devices. For non-recipient devices, there is little cost or confusion, as they would typically receive the PPDU as if it were for a standard-compliant device, mis-decode the PPDU, detect a wrong frame check sequence (FCS), and drop the frame(s) in the PPDU due to a mismatched receiver address (RA). This mechanism works well when the client device is connected to a single network, allowing efficient communication of proprietary features.

However, when the client device connects to multiple networks and/or with multiple APs, each supporting different features such as a) a higher standardized generation (where the previously-reserved bits have been allocated for some standardized purpose), b) the vendor-specific features of one vendor, c) the vendor-specific features of another vendor or d) no additional features, the device may struggle to track which features apply to received PPDUs particularly when sent to multiple users, such as Orthogonal Frequency Division Multiple Access (OFDMA) or Multi-User Multiple-Input-Multiple-Output (MU-MIMO) PPDUs. More specifically, it may become challenging for the device to determine the meaning of received and nominally reserved bits from a received PPDU.

Embodiments of the present disclosure introduce techniques to track the agreed-upon vendor-specific features across different networks using the AID assigned to the client device. When the same AID is assigned by two or more networks, causing potential confusion, the client device may send an AID change request to resolve the conflict and facilitate proper communication with the correct vendor-specific features. In some embodiments, the AID change request may include a simple request for a new AID without specifying alternatives. In some embodiments, the AID change request may include an AID Veto element, where the client device lists specific AIDs that should be avoided (e.g., AID 1), guiding the AP to assign a new AID from the available pool that does not overlap with the conflicting AIDs. Additionally, in some embodiments, the client device may maintain a mapping that associates the AID to the agreed-upon vendor-specific features. When receiving a PPDU from a peer such as an infrastructure AP, a Peer-to-Peer (P2P AP, a P2P Group Owner (GO) or an Independent Basic Service Set (IBSS) peer STA (and so forth) (henceforth referred to as “AP” for simplicity), the client device may refer to the mapping and update the reserved bits in the PPDU based on the agreed-upon features for the specific AP. Similarly, when decoding a PPDU received from the AP, the client device may use the mapping to correctly interpret the reserved bits based on the vendor-specific features, if any, agreed-upon with that AP. The disclosed mechanism allows for accurate application and decoding of vendor-specific features—or the absence of vendor-specific features—in wireless communications and prevents conflicts in multi-network environments.

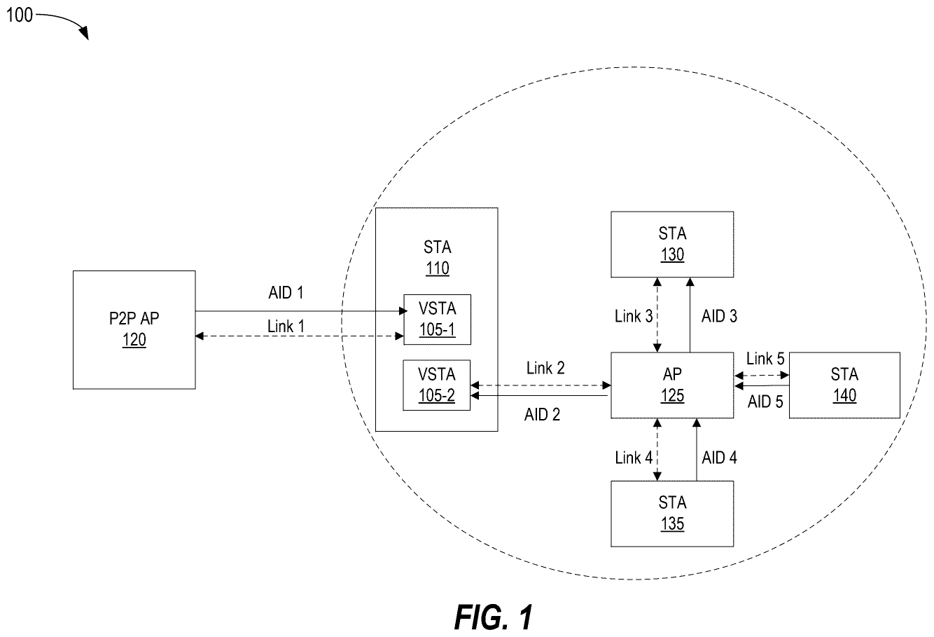

FIG. 1 depicts an example wireless environment 100 with a client device 110 connects to two different networks, according to some embodiments of the present disclosure.

In the example environment 100, the client device (also be referred to in some embodiments as a non-AP station (STA) or just STA) 110 includes two virtual STAs (VSTAs): VSTA 105-1 and VSTA 105-2. As used herein, a VSTA refers to a logical or virtual instance of a client device (or STA). VSTAs typically share the same physical wireless transceiver hardware, but each STA may independently connect to a different AP and maintain separate network sessions. In some embodiments, each STA may have its own independent station identifier (STAID). While the hardware (e.g., radio, antenna) is shared, each VSTA may maintain distinct controls over its connection and/or vendor-specific feature negotiations.

As depicted, VSTA 105-1 connects to a peer-to-peer AP 120 via link 1. During the association, the P2P AP 120 assigns an AID 1 to VSTA 105-1. VSTA 105-2 connects to an infrastructure AP 125 via link 2. The infrastructure AP 125 assigns AID 2 to VSTA 105-2. The infrastructure AP 125 also manages several other client devices. As illustrated, the infrastructure AP 125 connects to STA 130 via link 3 and assigns AID 3 to STA 130, the infrastructure AP 125 connects to STA 135 via link 4 and assigns AID 4 to STA 135, and the infrastructure AP 125 connects to STA 140 via link 5 and assigns AID 5 to STA 140. In some embodiments, the links 2-5 may correspond to an infrastructure network, such as a wireless local area network (WLAN). In embodiments where the P2P AP 120 is an infrastructure AP, Link 1 may correspond to an infrastructure network. In this configuration, each assigned AID (e.g., AID 1, 2, 3, 4, 5) is mapped to a corresponding Station ID (STAID) (e.g., STAID 1, 2, 3, 4, 5) and vice versa (e.g., the STAID is from the 11 least significant bits of the AID, and AIDs exceeding 11 bits are excluded from assignment to maintain compliance).

As used herein, the P2P AP 120 refers to a device acting as an AP in a Wi-Fi direct (peer-to-peer) connection. In some embodiments, the P2P AP 120 may also be referred to as P2P group owner (GO). The P2P AP 120 may not be a standard infrastructure AP, like AP 125. Instead, the P2P AP 120 may be included in a client device (e.g., a phone, tablet, or laptop) that manages connections in a P2P network.

In some embodiments, the AID may be assigned by each AP during the association process. The AID may include an integer, such as ranging between 1 and 2007.

In some embodiments, the AID may be used by the AP to distinguish between connected devices and apply the appropriate vendor-specific features negotiated during (or after) the association. For example, the infrastructure AP 125 may use AID 2 to identify VSTA 105, and apply the vendor-specific features negotiated with VSTA 105-2, or no vendor-specific features if none were negotiated. Similarly, AID 3 may be used by the infrastructure AP 125 to identify STA 130 and apply the vendor-specific features negotiated with STA 130 (or no VS features). AID 4 and AID 5 may be used for STA 135 and STA 140, respectively, each with their own set of negotiated vendor-specific features (or no VS features). As the assigner of AIDs, the infrastructure AP 125 ensures that each AID is unique to prevent confusion (e.g., avoiding assigning the same AID to multiple devices that have differences in their use of VS features). However, the AP does not manage AIDs globally for devices outside its network.

In some embodiments, the AID may also be used by the client device 110 to distinguish different APs it is connected to and track the features agreed upon, especially when the client device manages multiple VSTAs. The client device may maintain a mapping between the AID or the station identifier (STAID) of the VSTA, and either the agreed-upon vendor-specific features or the lack of such features. When generating (or decoding) a PPDU to (or from) a specific AP, the client device 110 may check the AID (or STAID) to ensure it applies the correct vendor-specific features in the PPDU. For example, the client device 110 may use AID 1 to determine the vendor-specific features negotiated between VSTA 105-1 the P2P AP 120, such as advanced modulation schemes (e.g., 16384-QAM), and use AID 2 to determine no vendor specific features or a different set of vendor-specific features negotiated between VSTA 105-2 and the infrastructure AP 125.

In embodiments where the AID 1 (assigned by the P2P AP 120) and the AID 2 (assigned by the infrastructure AP 125) are different, there is no ambiguity in communication. The client device 110 may use the different AIDs to easily differentiate between the two APs and apply the correct vendor-specific features to each connection. For example, AID 1 (assigned by the P2P AP 120) may be associated with a standard modulation scheme (e.g., 1024-QAM). AID 2 (assigned by the infrastructure AP 125) may be associated with a high-order modulation scheme (e.g., 16384-QAM), along with a vendor-specific low-power mode. With these distinct AIDs, the client device may correctly update the reserved bits (e.g., 3 reserved bits for dynamic vendor-specific feature negotiation within the U-SIG field) in the PPDU (e.g., “000” for default phase noise and EVM, default channel smoothing schemes, and modulation and coding schedule value of 1024-QAM, or “111” for low phase noise and EVM, a special smoothing scheme for UHR-LTF, and a high-order MCS value of 16384-QAM with 5/6 coding rate) in the PPDU to reflect the appropriate vendor-specific features for each AP.

However, in some embodiments, AID 1 (assigned by the P2P AP 120) and AID 2 (assigned by the infrastructure AP 125) may be identical or otherwise conflicting. This is because the AID range is relatively small (e.g., from 1 to 2007), and the client device 110 does not control the assignment of AIDs. In conventional settings, the client device 110 can only passively accept the AID assigned by each AP during association. Since there is no coordination or communication between the P2P AP 120 and the infrastructure AP 125, it is possible that both APs may assign the same AID to the client device 110 when establishing connections with respective VSTAs, including VSTA 105-1 and VSTA 105-2. The matching or conflicting AIDs may lead to confusion for the client device 110, as it may not know which set of vendor-specific features, or no vendor-specific features, to apply during communication. The features negotiated with the P2P AP 125 may conflict with those negotiated with the infrastructure AP 125. In the above example, AID 1 (assigned by the P2P AP 120) is associated with a standard modulation scheme (e.g., 1024-QAM), and AID 2 (assigned by the infrastructure AP 125) is associated with a high-order modulation scheme (e.g., 16384-QAM), along with a vendor-specific low-power mode. In such a configuration, the client device may mistakenly apply the low-power mode and 16384-QAM modulation features when receiving a PPDU from the P2P AP 120. As a result, the client device may not recognize or properly handle the PPDU due to the incorrect features.

To avoid confusion and ensure the client device 110 applies the correct vendor-specific features, especially when the client device has multiple VSTAs 105 associated with different networks, in some embodiments of the present disclosure, the client device 110 may perform a check on the assigned AIDs to prevent conflicts. More specifically, the client device 110 may check whether the AID conflicts with any other AIDs already assigned to the device (e.g., to one of the device's other VSTA(s) 105). In the example environment 100, if VSTA 105-1 is first associated with the P2P AP 120 and is assigned AID 1, the client device may store the AID 1. After that, when VSTA 105-2 attempts to connect to the infrastructure AP 125 and receives the AID 2, the client device 110 may check whether AID 2 conflicts with AID 1. If AID 2 is the same as AID 1, the client device 110 detects the conflict.

After a conflict is detected (e.g., AID 2 is the same as AID 1), in some embodiments, the client device 110 may generate and send an AID change request (e.g., a reassociation request frame or an AID Switch Request frame or a request in a vendor specific frame sent after the connection is established) to the infrastructure AP 125. This request may prompt the AP 125 to assign a new AID to the client device 110. The request may include either an AID change request (sub) field or (sub) element or an AID List Veto (sub) element.

In some embodiments, the AID change request (sub) element may simply include request a new AID without specifying alternatives or limits. In the example environment 100, upon receiving the AID change request element, the infrastructure AP 125 may select a new AID from its available pool, which excludes AID 2, which has been previously assigned to the client device 110 but was found to be in conflict, as well as AID 3, AID 4, and AID 5, which have already been assigned to other connected STAs.

In some embodiments, the AID List Veto (sub) element may include a list of AIDs that the client device 110 wishes to avoid (and/or a list of AIDs that the client device 110 would accept). In the example environment 100, the AID List Veto element may explicitly include AID 1. Upon receiving the AID List Veto element, the infrastructure AP 125 may avoid assigning AID 1. Additionally, the infrastructure AP 125 may exclude AID 2, which has been previously assigned to the client device 110 but was found to be in conflict, as well as AID 3, AID 4, and AID 5, which have already been allocated to other connected STAs.

By using the AID change request, the client device allows each AP to assign a unique AID. With the distinct AIDs assigned, the client device may avoid confusion and apply the appropriate vendor-specific features during communications.

The example STA 110 comprising two VSTAs are provided for conceptual clarity. In some embodiments, the STA 110 may include any number of VSTAs (including one), depending on the hardware and software capabilities of the client device.

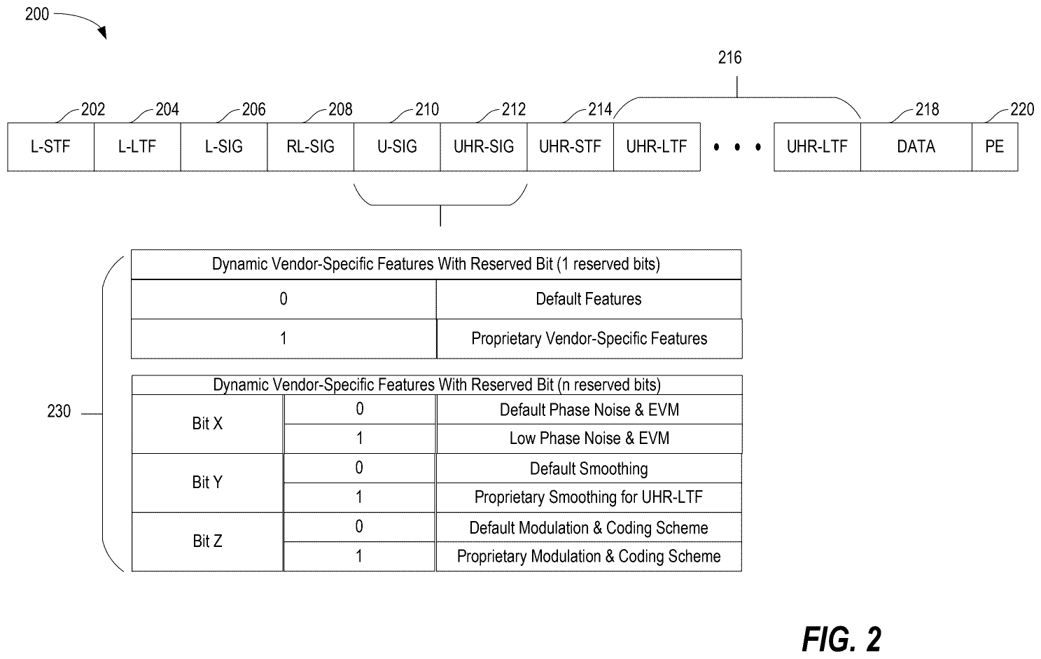

FIG. 2 depicts an example UHR PPDU 200, according to some embodiments of the present disclosure.

As depicted, the legacy short training field (L-STF) 202, legacy long training field (L-LTF) 204, legacy signal field (L-SIG) 206, and repeated legacy signal field (RL-SIG) 208 are legacy fields for backward compatibility. These fields provide information that helps legacy devices to detect the signal, estimate its transmission time, and process basic details about the PPDU 200.

The universal signal field (U-SIG) 210 carries information that is common across different generations of Wi-Fi and information that is common to all users of the PPDU. The U-SIG 210 may signal basic information, such as PHY format and bandwidth allocation, that can be interpreted by both UHR-capable devices and other devices to ensure the PPDU be properly processed.

The ultra-high reliability signal field (UHR-SIG) 212 is specific to UHR-capable devices and carries information about advanced features, such as higher-order modulation (e.g., 16384-QAM). The ultra-high reliability short training field (UHR-STF) 214 provides data that helps UHR-capable devices perform fine automatic gain control and prepare for data reception. The one or more ultra-high reliability long training fields (UHR-LTF) 216 are included to enable channel estimation for UHR-capable devices. The number of UHR-LTF fields 216 may depend on the number of spatial streams or antennas being used in the multiple input and multiple output (MIMO) configuration. The UHR-LTF fields 216 help UHR-capable devices accurately estimate the channel for optimal reception of the transmitted data.

The data field 218 carries the payload, which may include user data, management or control information. The data may be transmitted using the agreed-upon modulation and coding scheme (e.g., 16384-QAM for higher data rates). The package extension (PE) 220 is used to extend the PPDU 200. The PE 220 may include padding added to provide the receiver(s) with more time to complete decoding of the PPDU.

As depicted, both the U-SIG 210 and UHR-SIG fields 212 may include reserved bits which might be co-opted for vendor-specific feature negotiation. In embodiments where static vendor-specific features are applied, reserved bits may not be needed. In this configuration, static features are determined during upper-layer signaling (e.g., association). Once agreed, the AID serves as the identifier in the PPDU 200 to indicate that these specific vendor-specific features are active for this client device or groups of devices. For example, the AID may be tied to defined static vendor-specific features such as low phase noise, low EVM, a special smoothing scheme for UHR-LTF, or a redefined MCS value (e.g., 16384-QAM with 5/6 coding rate). The AID along signals the presence of these features. When receiving the PPDU including the AID, the receiving device automatically knows the associated vendor-specific features without requiring the reserved bits.

In embodiments where dynamic vendor-specific features are implemented, reserved bits may be used in the U-SIG 210 and UHR-SIG fields 212. As depicted, a single reserved bit may be allocated for general dynamic vendor-specific signaling: “0” (reserved value), which represents the agreed-upon default vendor-specific features, such as standard modulation schemes (e.g., 1024-QAM) and standard transmission parameters (e.g., standard phase noise or standard EVM), and “0”, which represents that proprietary vendor-specific features are enabled for the current PPDU, such as low phase noise, low EVM, a special smoothing scheme for UHR-LTF, or a redefined MCS value (e.g., 16384-QAM with 5/6 coding rate).

In some embodiments, multiple reserved bits may be used to signal independent vendor-specific features. This approach may provide more granular control over the PPDU's behavior. As depicted, reserved bit X is used to represent phase noise and EVM, with “0” (reserved value) assigned to represent standard phase noise and standard EVM, and “1” (non-reserved value) assigned to represent low phase noise and low EVM. Reserved bit Y is used to represent channel smoothing schemes, with “0” assigned to a standard smoothing scheme (e.g., basic channel estimation), and “1” (non-reserved value) assigned to a special smoothing scheme for UHR-LTF traffic. Reserved bit Z is used to represent modulation and coding scheme (MCS) settings, with “0” (reserved value) assigned to a standard modulation scheme (e.g., 1024-QAM), and “1” (non-reserved value) assigned to a vendor-specific redefined MCS value (e.g., 16384-QAM with a 5/6 coding rate). For example, if a PPDU includes the reserved bits as “000”, it represents the PPDU should be decoded using standard features, such as standard phase noise and EVM, standard smoothing, and a default MCS value (e.g., 1024-QAM). When the PPDU has reserved bits as “101”, it indicates that the PPDU should be decoded with low phase noise, low EVM, standard smoothing, and a redefined MCS value (e.g., 16384-QAM with a 5/6 coding rate). When the PPDU has reserved bit as “111,” it indicates that the PPDU should be decoded with low phase noise, low EVM, a special smoothing scheme for UHR-LTF, and a redefined MCS value (e.g., 16384-QAM with a 5/6 coding rate). The use of reserved bits allows flexible and independent signaling of vendor-specific features and enables dynamic adjustment per PPDU.

If the client device (e.g., 110 of FIG. 1) and AP (e.g., 125 of FIG. 1) are manufactured by the same vendor and the vendor has a single instance or generation of vendor specific behaviors, the predefined mapping 230 of values for these vendor-specific features may be integrated into the devices during manufacturing, allowing the devices to communicate without further negotiations beyond peer vendor determination, as both devices share a common understanding of what the reserved bits represent.

In other embodiments, such as when the client device (e.g., 110 of FIG. 1) includes multiple VSTAs (e.g., 105 of FIG. 1) and connects to multiple APs, or the vendor supports multiple generations of vendor specific signaling, the client device may not assume that each AP has a predefined understanding of vendor-specific features (e.g., the defined mapping 230). Instead, the client device may communicate to the AP (e.g., 125 of FIG. 1) the specific vendor-specific features it supports using a dynamic negotiation process. The AP may send a vendor-specific element via a discovery management frame (e.g., a beacon or probe response), informing recipients of the specific capabilities that the AP supports. In response or always, the client device may send a vendor-specific element via a management frame (e.g., an association or reassociation request frame), informing the AP of the specific capabilities that the client device supports. The AP may respond with an adjustment or confirmation, allowing both devices to align their understanding of the reserved bits and ensure proper communication of vendor-specific features.

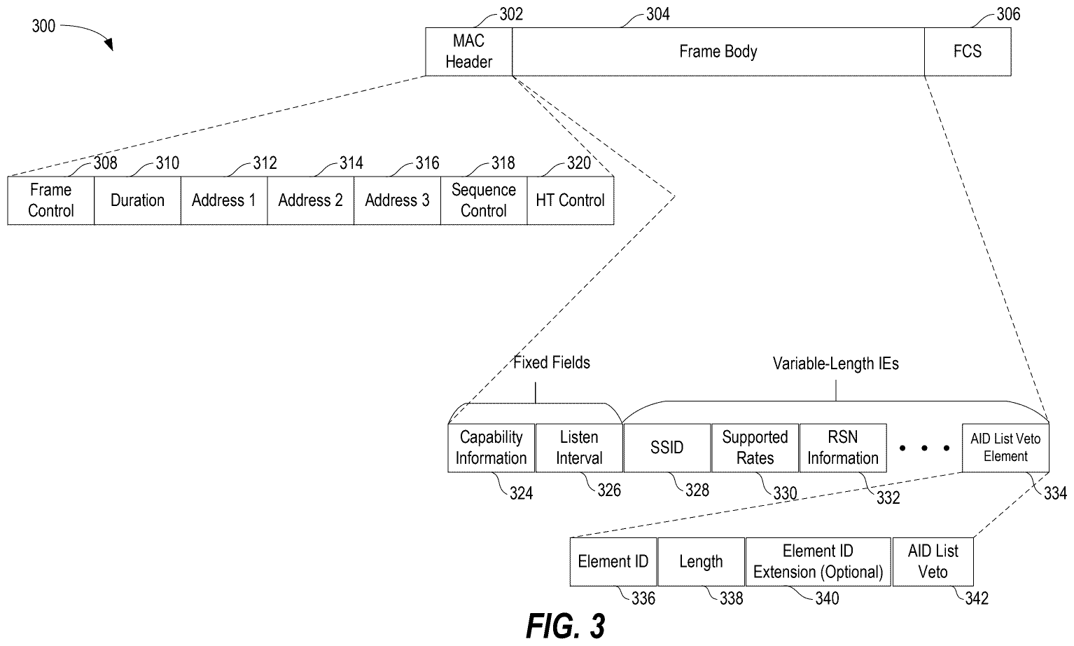

As discussed above, to track the vendor-specific features negotiated with each AP, the client device may use the AID assigned by each AP. This allows the client device to maintain a mapping of the agreed-upon features and their corresponding bit values for each AP. However, a problem arises when two or more APs assign the same AID to the client device. In such a configuration, the vendor-specific features negotiated with each AP—or the absence of such a negotiation—may conflict. For example, the first AP (e.g., the P2P AP 120 of FIG. 1) may use the reserved value “0” (e.g., in the reserved bit Z) to represent a standard modulation scheme like 1024-QAM and “1” to represent a higher-order scheme like 4096-QAM. In contrast, the second AP (e.g., the infrastructure AP 125 of FIG. 1) may use the reserved value “0” (e.g., in the reserved bit Z) to represent a standard modulation scheme like 1024-QAM and “1” represent 16384-QAM. In this scenario, the client device, since both APs assigned the same AID, may have difficulty distinguishing which of the vendor-specific features applies to a given PPDU based solely on the AID and reserved bits. For example, when the client device receives the PPDU 200, where the PPDU was transmitted by the first AP, the client device may mistakenly interpret the PPDU as sent by the second AP and then interpret the bit value “1” as indicating 16384-QAM and attempt to decode the received PPDU accordingly. However, the PPDU 200 was actually modulated using 4096-QAM modulation scheme by the first AP. This misinterpretation may lead to dropped frames, or even complete communication failures. To avoid this issue, the client device may send an AID change request to one of the APs, requesting a different AID assignment. More details regarding the AID change request are discussed below with reference to FIG. 3.

FIG. 3 depicts an example management frame 300 with an AID List Veto Element 334, according to some embodiments of the present disclosure.

As depicted, the management frame 300 includes three main parts: the MAC header 302, the frame body 304, and the frame check sequence (FCS) 306. In some aspects, the management frame 300 may be an association request sent when a client device (e.g., 110 of FIG. 1) is initially connecting to an AP (e.g., 125 of FIG. 1) a reassociation request, which is sent after the client device has already been associated with a network, or some other management frame.

The example MAC header 302 contains control and addressing information that helps the recipient device (e.g., 125 of FIG. 1) process the frame. As depicted, the MAC header 302 include seven fields, including the frame control field 308, the duration field 310, three address fields 312, 314, and 316, the sequence control field 318, and the HT control field 320. The frame control field 308 may indicate the type of frame (e.g., association or reassociation request). The duration field 310 may specify the time (e.g., in microseconds) that the frame will occupy the communication channel. The address fields 312, 314, and 316 may include the receiving device's address, the transmitting device's address, and the BSSID of the network, respectively. The sequence control field 318 may provide data to manage the sequence of frames, and the HT control field 320 may include control information specific to the communicating devices.

The frame body 304 contains management information and is divided into fixed-length fields and variable-length information elements (IEs). As depicted, the fixed fields include the capability information field 324 and the listen interval field 326. The capability information field 324 may provide information about the client device's capabilities, such as support for MAC-sublayer features such as enhanced distributed channel access (EDCA) and for PHY-layer features such as the short preamble introduced in 802.11b. The listen interval field 326 may indicate how often the client device wakes up to listen to transmission from the AP.

One or more variable-length information elements (IEs) are included within the example management frame, such as the service set identifier (SSID) element 328, the supported rates element 330, the robust security network (RSN) information element 332, and the AID List Veto element 334. The SSID element 328 may include the network name the client device is attempting to join. The supported rates element 330 may list the data rates that the client device can support during communication with the AP. The RSN information element 332 may contain details about the security protocols (e.g., WPA 1 or WPA 3) negotiated between the client and the AP. The AID List Veto element 334 may list AIDs the client device cannot accept.

As depicted, the AID List Veto element 334 may include four fields, including element ID 336, length 338, element ID extension (optional; included if a unique element ID is not available) 340, and AID Veto List 342. The element ID field 336 may include a unique identifier that indicates this is an AID List Veto element. The length subelement 338 may specify the length of the AID List Veto element 334. The element ID extension subelement 340 may provide additional information for identifying the AID List Veto element 334. The AID List Veto field 342 may include a list of AIDs that the client device requests to avoid. The list may help to resolve conflicts when multiple APs assign the same AID. For example, when the example management frame is sent by STA 110 of FIG. 1 to AP 125 of FIG. 1, the AID List Veto field 342 may indicate that AID 1 (assigned by P2P AP 120 of FIG. 1) should be avoided.

In some embodiments, instead of AID List Veto element 334, the management frame 300, such as an AID Switch Request frame, may include an AID request change signaling (i.e., one or more (sub) elements and/or (sub) fields). The AID request change signaling may simply indicate that the client device requests a new AID, without listing specific AIDs to avoid.

In some embodiments, the management frame 300 may be sent after the 4-way handshake process. In this configuration, the frame may be encrypted using the keys established during the handshake, further improving the security of the communication. In some embodiments, Authentication frames sent before the Association Request frames may establish key(s) for encrypting the Association Request and Association Response frames, so that a subsequent exchange for privacy is not needed.

In some embodiments, such as when the AID (e.g., AID 2 of FIG. 1) assigned by the AP (e.g., infrastructure AP 125 of FIG. 1) conflicts with an existing AID (e.g., AID 1 of FIG. 1), the AID List Veto element 334 or the AID request change signaling may be included in the message frames exchanged during either the 2nd step or the 4th step of the 4-way handshake process from the client device (e.g., 110 of FIG. 1) to the AP (e.g., infrastructure AP 125 of FIG. 1). This would allow the client to communicate AID conflicts and request changes during the key establishment process. Upon receiving these elements, the AP can adjust its AID assignment accordingly, either avoiding the AIDs (e.g., AID 1) listed in the Veto element or assigning a new AID as requested by the client.

In some embodiments, instead of being directly included in the frame body 304, the AID List Veto element 334 or the AID request change signaling may be embedded at multiple levels of encapsulation. For example, the AID List Veto field 342 or element 334 may be a (sub) field or (sub) element respectively of another element or subelement related to AID management or network resource control. In this configuration, the management frame 300 may have a more complex and modular structure, bundling related information into a single field or element for easier interpretation by the AP.

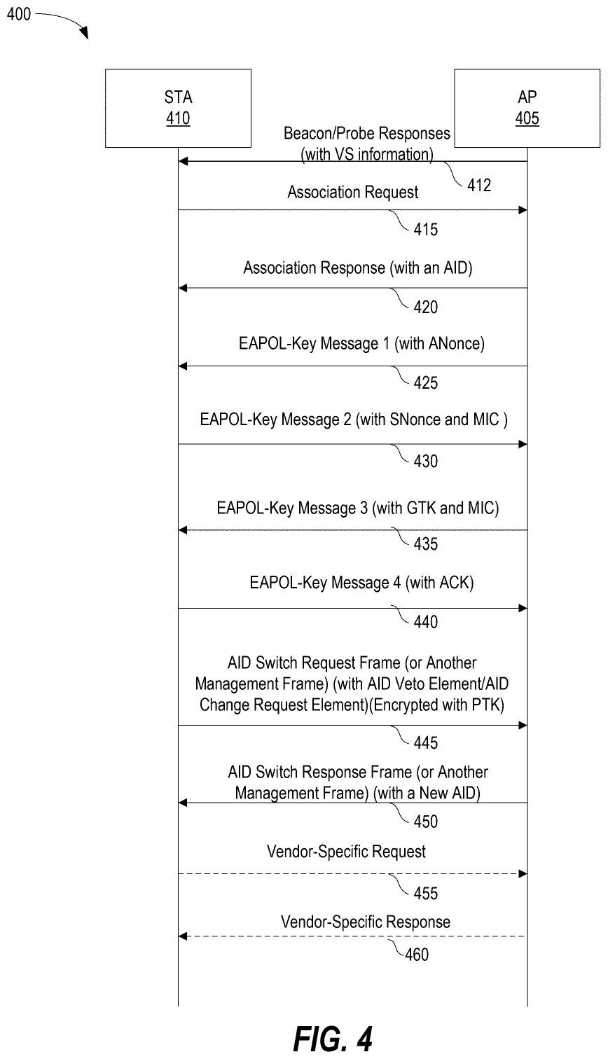

FIG. 4 depicts an example sequence 400 of message exchanges between a client device 410 and an AP 405 for association, AID assignment, and vendor-specific feature negotiation, according to some embodiments of the present disclosure. In some embodiments, AP 405 may correspond to P2P AP 120 or infrastructure AP 125 as depicted in FIG. 1, and the STA 410 may correspond to STA 110 as depicted in FIG. 1.

As depicted, the AP first sends beacon(s) or probe response(s) to the STA 410 (step 412), including vendor-specific (VS) element to communicate the supported features of the network. For example, the AP may indicate that specific reserved bits (e.g., bits 7-9 in the U-SIG field) are allocated to represent different modulation schemes, such as “0” for a standard modulation scheme (e.g., 1024-QAM), and “1” for a proprietary modulation scheme (e.g., 4096-QAM or 16384-QAM). Similar mappings may also be provided for phase noise & EVM, channel smoothing schemes, or other vendor-specific features. Subsequently, the STA 410 sends an association request to the AP 405 (step 415). In some embodiments, the association request may indicate the STA's 410 intent to join the network. Additionally, informed by the AP's advertised VS capabilities in its transmitted beacons and probe responses, the association request may include one or more similar vendor-specific (VS) elements. Theses VS elements indicate the vendor-specific features within an intersection of capabilities that are supported by both the client device and the network device, as well as implicitly or explicitly, how these features are signaled. In some embodiments, the VS element to communicate the supported vendor-specific features may be sent using a separate management frame (e.g., vendor-specific (VS) request) after the association or other processes are complete (after step 420, 440 or 450).

As depicted, the AP 405 processes the association request and sends an association response back to the STA 410 (step 420). The association response confirms the association is established so that the AP 405 and STA 410 can communicate via a connection link (e.g., link 1 as depicted in FIG. 1). The association response also includes an AID assigned by the AP 405 to the STA 410.

In embodiments where the one or more VS elements are included in the association request, the AP 405 may process the vendor-specific capabilities indicated by the STA 410. The association response may further confirm the vendor-specific features if the AP 405 supports these features entirely. In embodiments where the AP 405 does not fully support certain vendor-specific features, the response may suggest adjustments or modifications, indicating which features can be used under certain limitations. For example, the AP 405 may adjust the additional VS modulation schemes to better match its own capabilities. When the VS element is not included in the association request (e.g., the vendor-specific negotiation occurs after the association process is complete, like at steps 445 and 450), the association response may simply include an AID assigned to the client device and confirm that the association is established without further negotiation of vendor-specific features.

In some embodiments, the AID may be used by the AP 405 (e.g., AP 125 of FIG. 1) to distinguish STA 410 (e.g., STA 110 of FIG. 1) from other connected devices (e.g., STA 130, 135 or 140 of FIG. 1) within its network, allowing efficient management of data transmission and other network operations. When the STA 410 supports multiple virtual STAs (e.g., 105-1 and 105-2 of FIG. 1), each virtual VSTA may receive its own AID. The AID may be used by the client device 410 to manage communications between different APs or networks and the corresponding VSTAs. When vendor-specific features are negotiated, the AID may further be used by AP 405 and/or STA 410 to track the agreed-upon features, allowing the correct vendor-specific features are applied for each connection.

After the association is confirmed, the AP 405 initiates the 4-way handshake process by sending Extensible Authentication Protocol over Local Area Network (LAN) (EAPOL)-Key message 1 to the STA 410 (step 425). The EAPOL-Key message 1 includes the ANonce and additional cryptographic information required to establish a secure connection. As used herein, the ANonce refers to a random number generated by the AP 405. In some embodiments, other suitable network port authentication protocol besides EAPOL may be used.

In response to the AP's EAPOL-Key message 1, the STA 410 generates its own SNonce. As used herein, the SNonce refers to a random number generated by the STA 410. The STA 410 then calculates the pairwise transient key (PTK) using the ANonce, SNonce, and information such as the media access control (MAC) address of both devices. After that, the STA 410 sends EAPOL-Key message 2 back to the AP 405 (step 430), which includes the SNonce and a cryptographic message integrity check (MIC).

Upon receiving the SNonce, the AP 405 calculates the PTK in the same manner as the STA 410. The AP 405 then sends EAPOL-Key message 3 to the STA 410 (step 435), containing the group temporal key (GTK) used for encryption of multicast and broadcast traffic. The message also includes a MIC to validate the integrity of the message and confirm the successful calculation of the PTK on the AP's side.

The STA 410 receives the EAPOL-Key message 3 and installs both the PTK and the GTK. The STA 410 then sends EAPOL-Key message 4 to the AP 405 to confirm that the keys have been successfully installed (step 440). The message 4 completes the 4-way handshake and establishes a secure connection between the STA 410 and the AP 405, making the devices ready for future encrypted communication.

As discussed, the AID is assigned in the association response. Upon receiving the assigned AID, in some embodiments, the STA 410 may perform a check to determine whether the assigned AID conflicts with any other AIDs already in use by its VSTAs. If a conflict is detected, as depicted, the STA 410 sends a management frame such as an AID Switch Request frame (e.g., 300 of FIG. 3) to the AP 405 after the secure communication is established (step 445). In some embodiments, the management request frame may be a streamlined version of the AID Switch Request frame or a Reassociation frame (e.g., with the traditional reassociation semantics zeroed via special signaling). The request frame includes either an AID List Veto field (e.g., 342 of FIG. 3) or element (e.g., 334 of FIG. 3) or other AID change signaling (e.g. AID Request element in AID Switch Request frame). In some embodiments, the AID List Veto element may include at least a list of AIDs that are currently in use by the STA's other VSTAs. The AP 405 may use the list to assign a new AID from its available pool while avoiding the conflicting AIDs. In some embodiments, the AID change request signaling may simply request a new AID assignment from the AP 405 without specifying which AIDs to avoid. Upon receiving the AID change request signaling, the AP 405 may randomly assign a new AID from its available pool, as long as it is different from the first assigned AID (e.g., the AID included within the association response at step 415). In some embodiments, the reassociation request, containing either the AID List Veto element or AID change request signaling, is encrypted using the PTK established during the 4-way handshake. The encryption helps to keep that the AID change negotiation secure and protected from potential eavesdropping or interference.

In some embodiments, the AID List Veto element or AID change request signaling may be sent earlier in the 4-way handshake, such as in EAPOL-Key message 2 or in EAPOL-Key message 4. If sent in message 2, the AID List Veto element or AID change request signaling may not be encrypted, since the PTK is not yet available to the STA 410 or AP 405 at this stage of the handshake. Message 2 is primarily used by the STA to deliver its cryptographic information (e.g., the SNonce) to the AP 405 for generating the PTK. Therefore, any additional information, such as an AID List Veto element or AID change request signaling, may be sent in plaintext. In this configuration, the request for AID assignment may be potentially vulnerable to eavesdropping or tampering during transmission. If the AID List Veto element or AID change request signaling is sent in message 4, the element may be securely encrypted using the PTK, since both the AP 405 and STA 410 have successfully installed the PTK by this stage of the handshake. In this configuration, the request for AID assignment is protected from unauthorized interception or modification.

Upon receiving the frame requesting an AID change, the AP 405 processes the information provided by the STA 410 within the AID List Veto element or AID change request signaling, and generates and sends a response frame back to the STA 410 (step 450). The reassociation response includes a newly assigned AID and confirms that STA 410 can continue communication using the new AID. In some embodiments, the response frame may be encrypted using the PTK.

Once the STA 410 receives the response frame from the AP 405 containing the new AID, the STA 410 performs a check to determine whether the newly assigned AID conflicts with any other AIDs already in use by its other VSTAs. If the STA 410 confirms that the new AID is unique and non-conflicting, the STA 410 proceeds to use this AID for further communication with the AP 405. As discuss above, when the VS element is advertised in the probe responses or beacon frames, the VS negotiation may occur during the association process. Once the new AID is determined, it can be directly mapped to the agreed-upon features for future communications. However, when the VS information is not exchanged during the association process, the VS negotiation may occur after the AID is assigned. As depicted, after the AID is confirmed as non-conflicting, The STA 410 sends its supported vendor-specific features to the AP 405 via a management frame, such as a vendor-specific request (step 455). The AP 405 then responds with either confirmation of the supported features or suggests adjustments to ensure compatibility with its own capabilities (step 460). After the agreement on vendor-specific features is reached, both the STA 410 and the AP 405 map the agreed-upon features to the assigned AID for further communications. For example, when the STA 410 transmit data (e.g., 200 of FIG. 2) to the AP 405, the STA 410 may use the assigned AID to apply the appropriate features during packet generation. When the AP 405 receives the data with the AID, the AP may apply the corresponding features during packet processing (or decoding).

In some embodiments, the supported vendor-specific features may be communicated by the STA 410 in the initial association request (step 415), even before the AID is confirmed. In such configurations, once the AID is confirmed, the STA 410 may associate the newly assigned AID with the negotiated vendor-specific features, and continue communication using the agreed-upon settings for modulation schemes, power-saving features, or other proprietary capabilities. In some embodiments, the STA may send veto information in the association request 415 by including the AID List Veto subelement (e.g., 334 of FIG. 3) or field (e.g., 342 of FIG. 3). This subelement or field lists specific AIDs that the STA 410 requests the AP 405 to avoid when assigning a new AID. Upon receiving the association request, the AP may honor the AID veto list and ensure that the assigned AID does not conflict with any AID specified in the list. In parallel with the AID assignment, vendor-specific feature negotiation may be performed during the association process to align the STA 410 with the AP 405 on supported vendor-specific features and their signaling configurations. Once the negotiation is complete, the assigned AID is linked to the agreed-upon features for future communications.

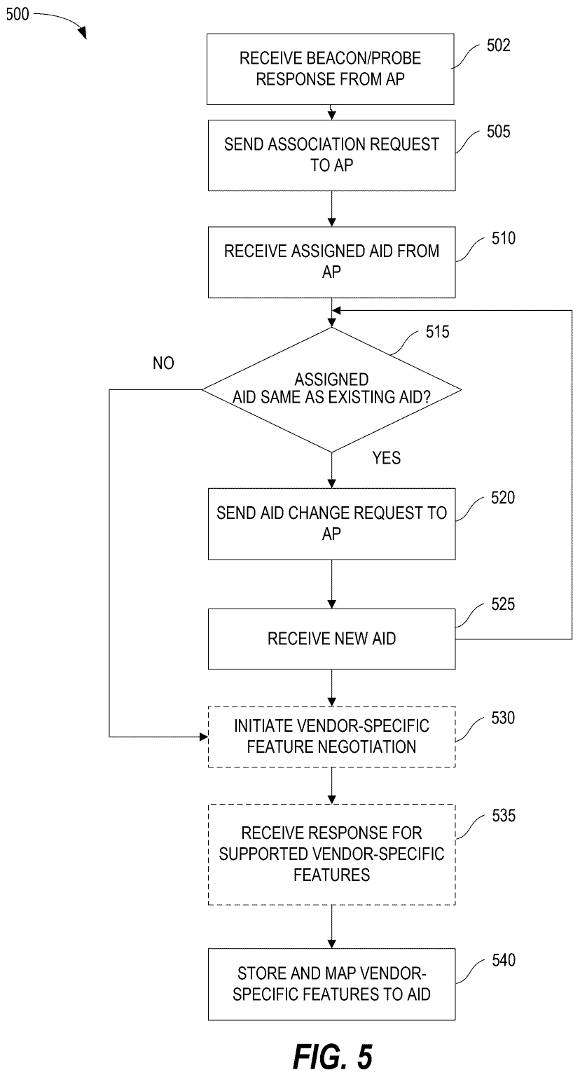

FIG. 5 depicts an example method 500 for a client device handling AID conflict and vendor-specific negotiation, according to some embodiments of the present disclosure. In some embodiments, the client device may correspond to STA 110 of FIG. 1 or STA 410 of FIG. 4.

At block 502, the client device (e.g., 110 of FIG. 1) scans for available networks and receives beacon frames or probe responses from one or more APs (e.g., 125 of FIG. 1). These frames may include vendor-specific (VS) information, indicating the AP's supported proprietary features and configurations. Based on the received VS information, the client device may determine the compatibility of its own vendor-specific capabilities with those of the AP.

At block 505, the client device (e.g., 110 of FIG. 1) initiates the process of connecting to an AP (e.g., 125 of FIG. 1) by sending an association request frame. The frame may indicate the client device's intent to join the network. Additionally, informed by the VS capabilities advertised by the AP in the beacons or probe responses, the client device may identify one or more features within an intersection of capabilities that are supported by both the client device and the AP. These features may include reduced transmitter impairments, improved modulation and/or coding schemes, improved channel smoothing schemes, or beamforming techniques (such as after taking the intersection of the AP's advertised and the client's known supported VS capabilities). Since the VS information supported by the AP and the STA are exchanged through the beacon frames (or probe responses) and the association request, an agreement on vendor-specific features can be reached during the association process. As a result, when the AID is confirmed, the new AID can be directly linked to the agreed-upon features and enables the application of these features in future communications. In some embodiments, however, the VS element may not be included in the probe responses, beacons, or the association request. In such configurations, the vendor-specific negotiation may occur after the association process is complete, as depicted at blocks 530 and 535.

At block 510, the client device receives an association response from the AP. The response confirms that the association has been established and includes the assignment of an AID to the client. In some embodiments, the AID may be sent in a separate management frame after the 4-way handshake process is complete. In this configuration, the management frame may be encrypted to avoid sending the AID in plaintext.

At block 515, the client device checks to determine whether the assigned AID conflicts with any AIDs already assigned to other VSTAs (e.g., 105-1 or 105-2 of FIG. 1) within the same client device. The check is performed to avoid conflicts between VSTAs connected to different APs (e.g., P2P AP 120 and AP 125 of FIG. 1).

If the client device detects a conflict with the newly assigned AID, the method 500 proceeds to block 520. If no conflict is detected and the newly assigned AID is confirmed to be unique, the method 500 skips blocks 520 and 525, and moves directly to block 530.

At block 520, the client device generates an AID change request (e.g., 300 of FIG. 3) to the AP. In some embodiments, the request may include an AID List Veto field (e.g., 342 of FIG. 3) (in some element) or an AID List Veto element (if standalone) (e.g., 334 of FIG. 3) that lists AIDs to be avoided. In some embodiments, the request may include an AID change request signaling that simply asks for a new AID. In some embodiments, the AID change request may be a management request frame, such as AID Switch Request, or Reassoication Request (e.g., with reassociation semantics zeroed), sent after the client device has already been associated with a network. In some embodiments, the AID change request may be encrypted with the PTK established during 4-way handshake.

In some embodiments, the AID List Veto field or element or AID change request signaling may be included in the messages exchanged during either the 2nd step or the 4th step of the 4-way handshake from the client to the AP (e.g., EAPOL-Key message 2 or EAPOL-Key message 4).

In some embodiments, a pre-association secure negotiation (PASN)-like exchange (e.g., as defined in 802.11bi) may be performed during the authentication process to establish cryptographic keys before the association process begins. This early security setup enables the encryption of subsequent management frames, including the association request. In this configuration, the client device may securely include sensitive information, such as the AID List Veto field (in some element) or AID List Veto element (if standalone), in the association request using keys from the PASN-like exchange. Upon receiving the association request, the AP may preemptively exclude conflicting AIDs from its pool of available AIDs when first assigning an AID to the client device.

At block 525, the client device receives a new AID from the AP. In some embodiments, the new AID may be sent via a management frame response. When the AID change request contains an AID List Veto element (e.g., 334 of FIG. 3), the AP may examine the list of AIDs that the client device has specified to avoid, exclude the conflicting AIDs from its available pool, and select a new AID that is unique and compliant with the request. When the AID change request includes an AID change request signaling (which does not specify conflicting AIDs but simply asks for a reassignment), the AP may randomly select a new AID from its available pool, as long as the new AID is different from the previously assigned AID and does not conflicts with any other AIDs in use. After receiving the new AID, the client device performs another round of checks to ensure that the new AID does not conflict with any existing AIDs in use. If the new AID is found to conflict, the cycle of sending an AID change request (including either an AID List Veto element or AID change request signaling) and receiving a new AID may be repeated until a unique, non-conflicting AID is successfully assigned by the AP.

As discussed above, the blocks 530 and 535 may be omitted when the VS elements are included in the AP's probe responses or beacons at block 502. In this configuration, once the AID is assigned at block 525, the method 500 moves directly to block 540, where the client device map the agreed-upon features to the assigned AID and store the mapping for future communications. However, when the VS elements are not included in the probe response or beacon, the vendor-specific feature negotiation occurs after the AID assignment. As depicted, after a new AID is assigned at block 530, the method proceeds to block 530, where the client device initiates a vendor-specific feature negotiation by sending a management frame, such as a vendor-specific request, to the AP. The frame includes a vendor-specific element, which indicates the vendor-specific capabilities that the client supports (e.g., reduced transmitter impairments, improved modulation and/or coding schemes, improved channel smoothing schemes, or beamforming techniques) and the use of reserved bits for specific functions (e.g., single reserved bit or multiple reserved bits in the U-SIG field). The vendor-specific element may also contain the mapping for these reserved bits to ensure proper interpretation by the AP (e.g., “0” in the reserved bit Z representing a standard modulation scheme (1024-QAM) and “1” in the reserved bit Z representing a proprietary vendor-specific modulation scheme (4096-QAM or 16384-QAM)).

At block 535, the client device receives the AP's response regarding the vendor-specific features proposed in the management frame (sent at block 530). The response either confirms that the AP supports the requested features or suggests adjustments to align with the AP's own capabilities.

At block 540, the client device stores the agreed-upon vendor-specific features and maps these features to the assigned AID. This mapping allows the client device to reference the correct settings when communicating with the peer devices. For example, if AID 1 is assigned and associated with specific vendor-specific features, like 16384-QAM modulation, the client may use these features when generating and/or decoding PPDUs (e.g., 200 of FIG. 2) for that AID.

In embodiments where the client device has multiple VSTAs associated with different networks (e.g., a P2P AP or an infrastructure AP), the example method 500 ensures that each VSTA receives a unique, non-conflicting AID. With the unique AIDs, the client device may manage vendor-specific features across different networks and prevent feature misapplication and communication errors.

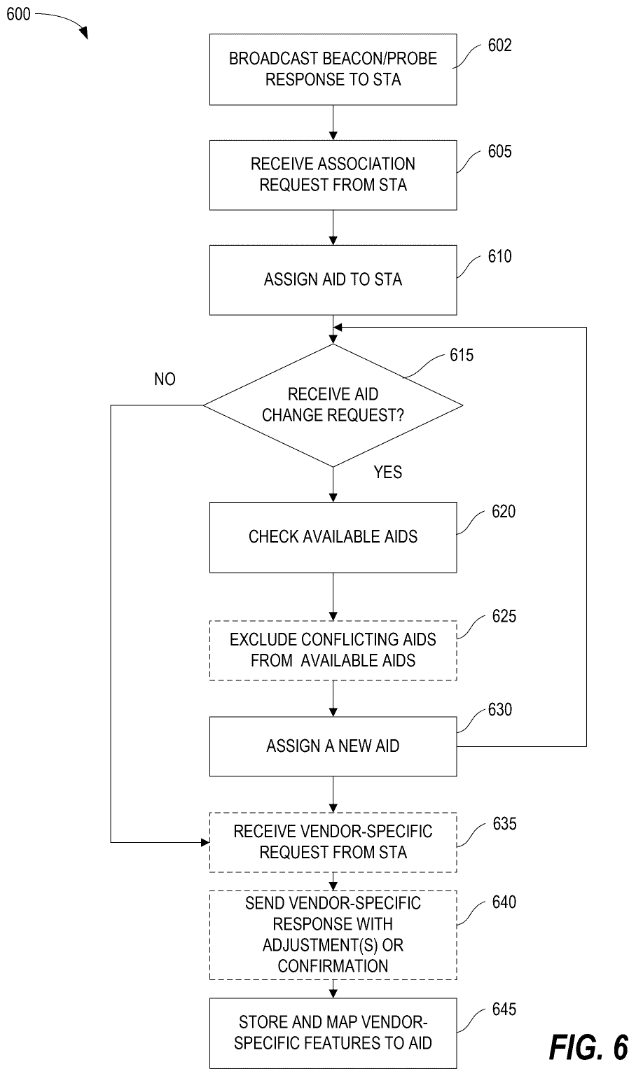

FIG. 6 depicts an example method 600 for an AP handling AID conflict and vendor-specific negotiation, according to some embodiments of the present disclosure. In some embodiments, the AP may correspond to P2P AP 120 or AP 125 of FIG. 1, or AP 405 of FIG. 4. In some embodiments, the example method 600 may not be limited to an AP, but may be performed by a wireless LAN controller (WLC) or any other network device capable of managing client associations and vendor-specific negotiations.

At block 602, the AP (e.g., 125 of FIG. 1) broadcasts beacon frames or responds to probe requests from nearby STAs (e.g., 110 of FIG. 1). In some embodiments, the beacon or probe responses may include VS information, such as the VS features supported by the AP (e.g., reduced transmitter impairments, improved modulation and/or coding schemes, improved channel smoothing schemes, or beamforming techniques).

At block 605, the AP (e.g., 125 of FIG. 1) receives an association request frame from a client device (e.g., 110 of FIG. 1). The request may be sent after the client device evaluates the intersection of its own capabilities and the AP's advertised capabilities based on the information received within the probe responses or beacons. In some embodiments, the frame may include one or more features within an intersection of capabilities that are supported by both the client device and the AP, such as reduced transmitter impairments, improved modulation and/or coding schemes, improved channel smoothing schemes, or beamforming techniques (such as after taking the intersection of the AP's advertised and the client's known supported VS capabilities). In embodiments where VS information is exchanged through the beacons (or probe responses) and the association request, the STA and AP may reach an agreement on the vendor-specific features during the association process (e.g., before the AID assignment is finalized). As a result, when the AID is confirmed (at block 630), the new AID can be directly linked to the agreed-upon features, omitting blocks 635 and 640 that involve post-association vendor-specific feature negotiation.

At block 610, the AP processes the association request and, if authenticated, assigns an AID to the client device. The AP then sends an association response back to the STA, which includes the assigned AID, confirming that the STA has been successfully associated with the network. The AID may be used by the AP to identify the client device within its network. In some embodiments, the AID may be sent in a separate management frame after the 4-way handshake process is complete. In this configuration, the management frame may be encrypted to avoid sending the AID in plaintext.

At block 615, the AP checks if it has received an AID change request from the client device. In some embodiments, the AID change request may be sent if the client device detects an AID conflict and requests a new AID assignment. The AID change request may be an AID Switch Request frame as depicted in FIG. 4, sent after the 4-way handshake is completed and securely encrypted using the PTK. The AID change request may include either an AID List Veto element (which specifies AIDs to avoid) or AID change request signaling (which simply requests a new AID assignment without listing specific conflicts). If the request for a new AID assignment is received, the method 600 proceeds to block 620. If no such request is received, the method 600 skips blocks 620-630 and moves directly to block 635.

At block 620, the AP checks for available AIDs. The AP needs to exclude the AIDs that have already been assigned to other STAs (e.g., 130, 135, or 140 of FIG. 1) from the pool of potential AIDs for reassignment to avoid conflicts.

At block 625, if the AID change request from the client device contains an AID List Veto element, the AP excludes the conflicting AIDs listed in the element from the available pool of AIDs. The operation at block 625 may only apply when the AID List Veto element is included in the AID change request. When the AID change request signaling is included, which does not list specific AIDs to avoid, the operation at block 625 may be skipped, and the AP may randomly select a new AID from its available pool without checking for specific conflicts.

At block 630, the AP assigns a new AID to the client device. In some embodiments, the new AID may be sent back to the STA in a reassociation response. Upon receiving the new AID, the client device performs another round of check to determine whether the new AID conflicts with any existing AIDs already in use by its VSTAs. If the new AID does not conflict, the method 600 moves to block 635, where the vendor-specific negotiation is initiated. However, if a conflict is found, the client device sends another request for a new AID assignment. The cycle of receiving AID change requests, checking available AIDs, and assigning a new AID may be repeated until the AP assigns a unique, non-conflicting AID to the client device.

In some embodiments, the AID List Veto field (in some element) or element (if standalone) and/or the AID change request signaling may be included within the initial association request received at block 605. The association request may be encrypted using keys from a PASN-like exchange (e.g., the pairwise transient key (PTK)), which is established during the authentication process. Upon receiving the association request, at block 610, the AP may preemptively exclude conflicting AIDs from its pool of available AIDs when first assigning an AID to the client device.

As discussed above, the blocks 635 and 640 may be omitted when the VS elements are included in the AP's probe responses or beacons at block 602. In this configuration, once the AID is assigned at block 630, the method 600 moves directly to block 645, where the AP maps the agreed-upon vendor-specific features to the AID and stores the mapping for future communications. However, when the VS elements are not exchanged during the association process, such as not being included in the probe responses (or beacon frames) and the association request, the vendor-specific negotiation occurs after the AID assignment. As depicted, at block 635, after a non-conflicting AID is confirmed, the AP receives a vendor-specific request frame from the client device. In some embodiments, the request may include a vendor-specific element, which details the vendor-specific features the client device supports, such as custom modulation schemes, and the use of reserved bits for these features.

At block 640, the AP processes the vendor-specific request and responds with either a confirmation or adjustments to the requested vendor-specific features. Through the response, the AP and client device confirm the agreed-upon vendor-specific features for the assigned AID.

At block 645, the AP stores the mapping between the assigned AID and the negotiated vendor-specific features. The mapping is maintained for future communications so that the correct vendor-specific features are consistently applied when the client device communicates using the assigned AIDs. For example, if AID 1 is assigned and associated with features such as 4096-QAM modulation, the AP may encode and/or decode PPDUs for AID 1 (e.g., 200 of FIG. 2) using the agreed-upon modulation scheme.

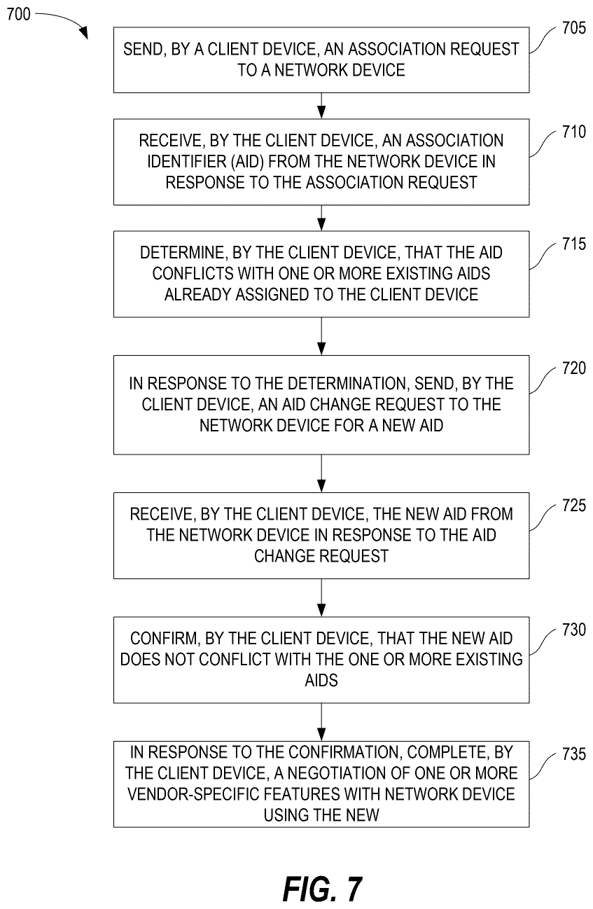

FIG. 7 is a flow diagram depicting an example method 700 for AID conflict resolution, according to some embodiments of the present disclosure.

At block 705, a client device (e.g., 110 of FIG. 1) sends an association request to a network device (e.g., P2P AP 120 or AP 125 of FIG. 1). In some embodiments, the network device may comprise at least one of an infrastructure access point (AP) (e.g., 125 of FIG. 1) or a peer-to-peer (P2P) group owner (GO) (e.g., 120 of FIG. 1).

In some embodiments, the client device may comprise one or more virtual stations (VSTAs) (e.g., 105-1 and 105-2 of FIG. 1), and the association request indicates an intent of the client device to connect to the network device through one of the one or more VSTAs.

At block 710, the client device receives an association identifier (AID) (e.g., AID 1) from the network device in response to the association request.

At block 715, the client device determines that the AID (e.g., AID 1) conflicts with one or more existing AIDs already assigned to the client device.

At block 720, the client device, in response to the determination, sends an AID change request (e.g., the reassociation request as depicted in FIG. 4) to the network device for a new AID. In some embodiments, the AID change request may be encrypted using a pairwise encryption key, and the pairwise encryption key may be established through a 4-way handshake process (e.g., steps 425-440 as depicted in FIG. 4) or a pre-association secure negotiation (PASN)-like exchange process (e.g., during the authentication process) between the client device and the network device.

At block 725, the client device receives the new AID (e.g., AID 2) from the network device in response to the AID change request.

At block 730, the client device confirms that the new AID does not conflict with the one or more existing AID.

At block 735, the client device, in response to the confirmation, completes a negotiation of one or more vendor-specific features with network device using the new AID.

In some embodiments, the AID change request may comprise an AID change request signaling, the AID change request signaling indicating a request for the new AID without specifying any preferred AIDs.

In some embodiments, the network device, upon receiving the AID change request signaling, may select the new AID from a list of unused AIDs, and wherein the list of unused AIDs excludes AIDs that were previously assigned by the network device to other connected client devices that remain in use in a same network.

In some embodiments, the AID change request may comprise an AID List Veto element (e.g., 334 of FIG. 3), the AID List Veto element listing the one or more existing AIDs already assigned to the client device.

In some embodiments, the network device, upon receiving the AID List Veto element, may select the new AID from a list of unused AIDs, and wherein the list of unused AIDs excludes the one or more existing AID and AIDs that were previously assigned by the network device to other connected client devices that remain in use in a same network.

In some embodiments, the AID change request may be sent by the client device to the network device during a second or fourth step of a 4-way handshake process.

In some embodiments, the association request may comprise at least one of an AID change request signaling or an AID List Veto element, and the association request may be encrypted using keys established from a pre-association secure negotiation (PASN)-like exchange process.

In some embodiments, the negotiation of the one or more vendor-specific features with network device using the new AID may comprise identifying, by the client device, the one or more vendor-specific features supported by the client device, sending, by the client device to the network device, a vendor-specific element indicating the one or more vendor-specific features, receiving, by the client device, a response from the network device, comprising an indication of one or more vendor-specific features within an intersection of capabilities that are supported by both the network device and the client device, and creating, by the client device, a mapping that associates the one or more vendor-specific features within the intersection to the new AID.

In some embodiments, prior to sending the association request, the client device may receive one or more beacon frames or probe responses from the network device (e.g., 412 of FIG. 4), where the one or more beacon frames or probe responses comprise one or more vendor-specific features supported by the network device, and the association request is sent after evaluating the one or more beacon frames or probe responses and comprises an indication of one or more vendor-specific features within an intersection capabilities that are supported by both the network device and the client device. In some embodiments, the negotiation of the one or more vendor-specific features with network device using the new AID may comprise creating, by the client device, a mapping that associates the one or more vendor-specific features within the intersection to the new AID.

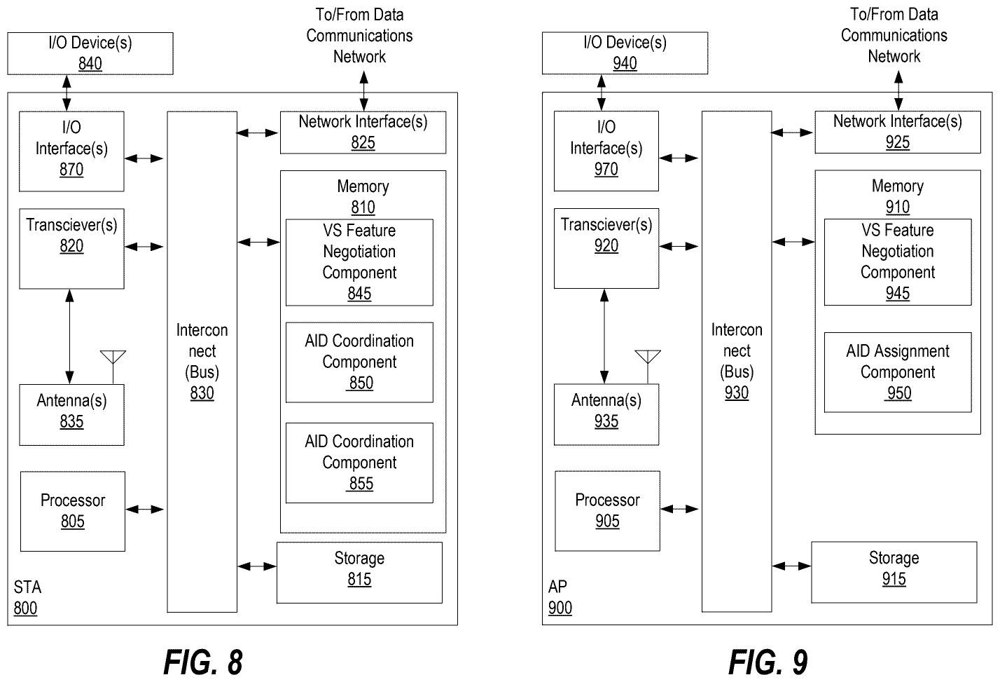

FIG. 8 depicts an example client device 800 configured to perform various aspects of the present disclosure, according to some aspects of the present disclosure. In some embodiments, the example client device 800 may correspond to STA 110 as depicted in FIG. 1, or STA 410 as depicted in FIG. 4.

As illustrated, the example client device 800 includes a processor 805, memory 810, storage 815, one or more transceivers 820, one or more I/O interfaces 880, and one or more network interfaces 825. In some embodiments, I/O devices 840 are connected via the I/O interface(s) 880. Further, via the network interface 825, the network device 800 can be communicatively coupled with one or more other devices and components (e.g., via a network, which may include the Internet, local network(s), and the like). Each of the components is communicatively coupled by one or more buses 830. In some embodiments, one or more antennas 835 may be coupled to the transceivers 820 for transmitting and receiving wireless signals.

The processor 805 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 805 processes information received through the transceiver 820, I/O interfaces 880, and the network interfaces 825. The processor 805 retrieves and executes programming instructions stored in memory 810, as well as stores and retrieves application data residing in storage 815.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 810 may include random access memory (RAM) and read-only memory (ROM). The memory 810 may store processor-executable software code containing instructions that, when executed by the processor 805, enable the network device 800 to perform various functions described herein for wireless communication. In the illustrated example, the memory 810 includes three software components: the vendor-specific (VS) feature negotiation component 845, the AID coordination component 850, and the VSTA management component 855.

The VS feature negotiation component 845 is configured to manage the negotiation of vendor-specific features between the client device 800 and its associated APs. In one embodiment, the VS feature negotiation component 845 may advertise the device's vendor-specific capabilities to the AP during or after the association process. The VS feature negotiation component 845 may also process responses from the AP regarding supported features, and store the mapping between the agreed-upon vendor-specific features and the assigned AID.

The AID coordination component 850 is configured to track AID assignment for the client device 800, particularly when the client device 800 has multiple virtual STAs. In one embodiment, the AID coordination component 850 may check for conflicts when new AIDs are assigned to maintain that there are no overlaps with existing AIDs used by other VSTAs. If a conflict is detected, the AID coordination component 850 may generate a request that may include an AID List Veto element or AID change request signaling, asking the AP to assign a new, non-conflicting AID.

The VSTA management component 855 manages the creation, configuration, and coordination of the VSTAs within the client device 800. Although sharing the same physical hardware, each VSTA (e.g., 105-1 or 105-2 of FIG. 1) is configured as an independent logical entity, allowing it to independently associate with a different network or AP. In one embodiment, the VSTA management component 855 may allocate resources such as memory, buffers, and processing power to ensure each VSTA operates independently. When multiple VSTAs are created and AIDs are assigned, the component 855 may coordinate traffic between the VSTAs to prevent conflict and ensure that the correct vendor-specific features are applied to encode and/or decode PPDUs (e.g., 200 of FIG. 2) for each VSTA.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

FIG. 9 depicts an example network device 900 configured to perform various aspects of the present disclosure, according to some aspects of the present disclosure. In some embodiments, the network device 900 may correspond to an AP, such as P2P AP 120 or AP 125 of FIG. 1, or AP 405 of FIG. 4. In some embodiments, the network device 900 may correspond to a WLC or any other network device capable of managing client associations and vendor-specific negotiations.

As illustrated, the example network device 900 includes a processor 905, memory 910, storage 915, one or more transceivers 920, one or more I/O interfaces 980, and one or more network interfaces 925. In some embodiments, I/O devices 940 are connected via the I/O interface(s) 980. Further, via the network interface 925, the network device 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 980, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 may include random access memory (RAM) and read-only memory (ROM). The memory 910 may store processor-executable software code containing instructions that, when executed by the processor 905, enable the network device 900 to perform various functions described herein for wireless communication. In the illustrated example, the memory 910 includes two software components: the vendor-specific (VS) feature negotiation component 945 and the AID assignment component 950.

The VS feature negotiation component 945 is configured to manage the negotiation of vendor-specific features with the client device (e.g., 800 of FIG. 8). In one embodiment, the VS feature negotiation component 945 may process incoming VS elements from the client device, determine whether the requested features are supported by the AP 900, and send a confirmation or adjustment response. Once an agreement is reached, the VS feature negotiation component 945 may map the agreed-upon vendor-specific features to the assigned AID for the client device.

The AID assignment component 950 is configured to handle the process of assigning AIDs to client devices during or after the association process. In one embodiment, the AID assignment component 950 may check the available pool of AIDs and assign a unique AID to each STA within its network. When a conflict is detected by a client device, such as when the assigned AID is the same as an AID already in use by the client's other VSTA, the client device may send a request to the network device 900, asking for a new AID assignment. If the request includes an AID change request signaling, which simply requests a new AID without specifying any conflicting AIDs, the AID assignment component 950 may randomly assign a new AID from the available pool, as long as the new AID is different from the first assigned AID and does not conflict with any other AIDs already in use. If the request includes an AID List Veto element, which lists specific AIDs that should be avoided, the AID assignment component 950 may exclude the Vetoed AIDs from the available pool before assigning a new AID.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
sending, by a client device, an association request to a network device;
receiving, by the client device, an association identifier (AID) from the network device in response to the association request;
determining, by the client device, that the AID conflicts with one or more existing AIDs already assigned to the client device;
in response to the determination, sending, by the client device, an AID change request to the network device for a new AID;
receiving, by the client device, the new AID from the network device in response to the AID change request;
confirming, by the client device, that the new AID does not conflict with the one or more existing AIDs; and
in response to the confirmation, completing, by the client device, a negotiation of one or more vendor-specific features with the network device using the new AID.

2. The method of claim 1, wherein the network device comprises at least one of an infrastructure access point (AP) or a peer-to-peer (P2P) group owner (GO).

3. The method of claim 1, wherein the client device comprises one or more virtual stations (VSTAs), and the association request indicates an intent of the client device to connect to the network device through one of the one or more VSTAs.

4. The method of claim 1, wherein the AID change request is encrypted using a pairwise encryption key, and wherein the pairwise encryption key is established through a 4-way handshake process or a pre-association secure negotiation (PASN)-like exchange process between the client device and the network device.

5. The method of claim 1, wherein the AID change request comprises an AID change request signaling, the AID change request signaling indicating a request for the new AID without specifying any preferred AIDs.

6. The method of claim 5, wherein the network device, upon receiving the AID change request signaling, selects the new AID from a list of unused AIDs, and wherein the list of unused AIDs excludes AIDs that were previously assigned by the network device to other connected client devices that remain in use in a same network.

7. The method of claim 1, wherein the AID change request comprises an AID List Veto element, the AID List Veto element listing the one or more existing AIDs already assigned to the client device.

8. The method of claim 7, wherein the network device, upon receiving the AID List Veto element, selects the new AID from a list of unused AIDs, and wherein the list of unused AIDs excludes the one or more existing AIDs and AIDs that were previously assigned by the network device to other connected client devices that remain in use in a same network.

9. The method of claim 1, wherein the AID change request is sent by the client device to the network device during a second or fourth step of a 4-way handshake process.

10. The method of claim 1, wherein the association request comprises at least one of an AID change request signaling or an AID List Veto element, and wherein the association request is encrypted using keys established from a pre-association secure negotiation (PASN)-like exchange process.

11. The method of claim 1, wherein completing the negotiation of the one or more vendor-specific features with the network device using the new AID comprises:
identifying, by the client device, the one or more vendor-specific features supported by the client device;
sending, by the client device to the network device, a vendor-specific element indicating the one or more vendor-specific features;
receiving, by the client device, a response from the network device, comprising an indication of one or more vendor-specific features within an intersection of capabilities that are supported by both the network device and the client device; and
creating, by the client device, a mapping that associates the one or more vendor-specific features within the intersection to the new AID.

12. The method of claim 1, further comprising:
prior to sending the association request, receiving, by the client device, one or more beacon frames or probe responses from the network device, wherein the one or more beacon frames or probe responses comprise one or more vendor-specific features supported by the network device,
wherein the association request is sent after evaluating the one or more beacon frames or probe responses, and comprises an indication of one or more vendor-specific features within an intersection capabilities that are supported by both the network device and the client device.

13. The method of claim 12, wherein completing the negotiation of the one or more vendor-specific features with the network device using the new AID comprises:
creating, by the client device, a mapping that associates the one or more vendor-specific features within the intersection to the new AID.

14. A system of a client device, comprising:
one or more memories collectively containing one or more programs;
one or more processors, wherein the one or more processors are configured to, individually or collectively, perform an operation comprising:
sending, by a client device, an association request to a network device;
receiving, by the client device, an association identifier (AID) from the network device in response to the association request;
determining, by the client device, that the AID conflicts with one or more existing AIDs already assigned to the client device;
in response to the determination, sending, by the client device, an AID change request to the network device for a new AID;
receiving, by the client device, the new AID from the network device in response to the AID change request;
confirming, by the client device, that the new AID does not conflict with the one or more existing AIDs; and
in response to the confirmation, completing, by the client device, a negotiation of one or more vendor-specific features with the network device using the new AID.

15. The system of claim 14, wherein the network device comprises at least one of an infrastructure access point (AP) or a peer-to-peer (P2P) group owner (GO).

16. The system of claim 14, wherein the AID change request is encrypted using a pairwise encryption key, and wherein the pairwise encryption key is established through a 4-way handshake process or a pre-association secure negotiation (PASN)-like exchange process between the client device and the network device.

17. The system of claim 14, wherein the AID change request comprises an AID change request signaling, the AID change request signaling indicating a request for the new AID without specifying any preferred AIDs.

18. The system of claim 17, wherein the network device, upon receiving the AID change request signaling, selects the new AID from a list of unused AIDs, and wherein the list of unused AIDs excludes AIDs that were previously assigned by the network device to other connected client devices and remained in use in a same network.

19. The system of claim 14, wherein the AID change request comprises an AID List Veto element, the AID List Veto element listing the one or more existing AIDs already assigned to the client device.

20. One or more non-transitory computer-readable media containing, in any combination, computer program code that, when executed by a computer system, performs an operation comprising:
sending, by a client device, an association request to a network device;
receiving, by the client device, an association identifier (AID) from the network device in response to the association request;
determining, by the client device, that the AID conflicts with one or more existing AIDs already assigned to the client device;
in response to the determination, sending, by the client device, an AID change request to the network device for a new AID;
receiving, by the client device, the new AID from the network device in response to the AID change request;
confirming, by the client device, that the new AID does not conflict with the one or more existing AIDs; and
in response to the confirmation, completing, by the client device, a negotiation of one or more vendor-specific features with the network device using the new AID.

21. A method, comprising:
sending, by a client device, an association request to a network device, wherein the association request comprises an association identifier (AID) List Veto element that specifies one or more existing AIDs already assigned to the client device;
receiving, by the client device, an AID assigned by the network device in response to the association request, the assigned AID being selected based on the AID List Veto element to avoid conflicts;
confirming, by the client device, that the assigned AID does not conflict with the one or more existing AIDs; and
in response to the confirmation, completing, by the client device, a negotiation of one or more vendor-specific features with the network device using the assigned AID.

22. The method of claim 21, further comprising:
storing, by the client device, a mapping between the assigned AID and the one or more vendor-specific features negotiated with the network device; and
updating the AID List Veto element to include the assigned AID.
